(19) United States
(12) Patent Application Publication
(10) Pub. No.: US 2012/0162169 A1
(43) Pub. Date: Jun. 28, 2012

(54) ACTIVE MATRIX TYPE ORGANIC EL DISPLAY DEVICE AND ITS DRIVING METHOD

(75) Inventor: Shinichi Ishizuka, Mitaka (JP)

(73) Assignee: PIONEER CORPORATION, Kawasaki-shi, Kanagawa (JP)

(21) Appl. No.: 13/378,786

(22) PCT Filed: Jun. 19, 2009
(86) PCT No.: PCT/JP2009/061210

§ 371 Date: Mar. 13, 2012

(51) Int. Cl. G09G 3/30; G09G 5/10

(52) U.S. Cl. 345/207; 345/77

(57) ABSTRACT

To control a chronological luminance decrease of an organic EL element in an active matrix drive type organic EL display and to provide a reliable organic EL display. An organic EL display comprising a luminance decrease detector to detect a luminance decrease of an organic EL element; a reverse bias voltage generator to generate a reverse bias voltage pulse according to an amount of the luminance decrease; and a controller to control applying the above reverse bias voltage pulse to a driving transistor in a time period in which the organic EL element emits no light.

### TECHNICAL FIELD

The present invention relates to an active matrix type organic EL display device having an organic EL element as a light emitting element and its driving method.

### BACKGROUND ART

Active matrix type organic EL displays are thin and enable to realize a high quality image display and have been actively researched and developed. FIG. 1 illustrates one example of an equivalent circuit of a driving circuit of an organic EL (Organic Electroluminescent) element (OEL) 100 by using one pixel of the display. By referencing FIG. 1, this equivalent circuit includes two p-channel TFTs (Thin Film Transistor) 101, 102 that are active elements and a capacitor (Cs) 104. A scanning line Wₛ is connected to a gate of the selective TFT 101, a data line W_{D} is connected to a source of the selective TFT 101, and a power source line W_{z} that supplies a constant power source voltage V_{DD} is connected to a source of the driving TFT 102. A drain of the selective TFT 101 is connected to a gate of the driving TFT 102, wherein the capacitor 104 is formed between the gate and the source of the driving TFT 102. An anode of the OEL 100 is connected to a drain of the driving TFT 102, while a cathode thereof is connected to a common potential respectively.

When a selective pulse is applied to the scanning line Wₛ, the selective TFT 101 that serves as a switch is turned on and the state between the source and the drain becomes conductive. At this time, a data voltage is supplied from the data line W_{D} via the source and the drain of the selective TFT 101 to be accumulated in the capacitor Cs 104. Since the data voltage accumulated in the capacitor 104 is applied between the gate and the source of the driving TFT 102, a drain current ld corresponding to the voltage (hereafter, referred to as a gate voltage) Vgs between the gate and the source of the driving TFT 102 flows so as to be supplied to the OEL 100.

However, the emission luminance of the organic EL element (OEL) decreases with a driving time. FIG. 2 is a graph illustrating a change of the luminance (L) to the driving time of the organic EL element (OEL). This illustrates the change in a pattern diagram when a driving current (I) is constant. Furthermore, the luminance (L) of the organic EL element is illustrated by normalizing the luminance (L₀) in an initial state (point in which the driving time is 0) to be 1 (100%). As illustrated in FIG. 2, even if the organic EL element is driven by a constant current, the luminance-current (L-I) characteristic changes with the driving time, wherein the emission luminance decreases chronologically.

On the other hand, it is known that in the organic TFTs (driving transistor), a threshold voltage shifts with the driving time (for example, refer to Non-Patent Literature 1). Such a shift of a threshold voltage of the driving transistor causes the OEL to lose the emission luminance. A driving circuit and a driving method to compensate the shift of a threshold voltage of the organic TFT are disclosed in the Patent Documents 1-3, for example. However, it is extremely important to control the chronological luminance decrease of the organic EL elements as described above and to realize reliable organic EL displays.

### CITATION LIST

Non Patent Literature

NPL 1: S. J. Zilker, C. Detcheverry, E. Cantatore, and D. M. deLeeuw, “Bias stress in organic thin-film transistors and logic gates,” Applied Physics Letters Vol 79 (8) pp. 1124-1126, Aug. 20, 2001.

Patent Literature

PTL 1 Japanese Translation of PCT International Application Publication No. 2002-514320 (pp. 13-15, FIGS. 2, 3)

PTL 2: Japanese Patent Kokai No. 2002-351401 (p. 4, FIG. 1)

PTL 3: Japanese Patent Kokai No. 2006-351401 (p. 11, FIG. 5)

### SUMMARY OF INVENTION

### Technical Problem

As problems to be solved by the present invention, the above problem can be cited as one example. A purpose of the present invention is to control a chronological luminance decrease of an organic EL element in an active matrix drive type organic EL display and to provide a reliable organic EL display. Other purpose is to provide a reliable color display device having an excellent color rendering property.

### Solution To Problem

A display device of the present invention has an active matrix type display panel consisting of a plurality of display cells, each of which has an organic EL (Electroluminescent) element and a driving transistor which drives the organic EL element on the basis of a data signal wherein each scanning line of the display panel is scanned in sequence, and the data signal is supplied to the display cell according to the scanning, to perform displays, the display device comprising:

a luminance decrease detector to detect a luminance decrease of the organic EL element;

a reverse bias voltage generator to generate a reverse bias voltage pulse according to an amount of the above luminance decrease; and

a controller to control applying the above reverse bias voltage pulse to the driving transistor in a time period in which the organic EL element emits no light.

The driving method of the present invention is a driving method of a display device comprising an active matrix type display panel consisting of a plurality of display cells each having an organic EL (Electroluminescent) element and a driving transistor which drives the organic EL element on the basis of a data signal wherein each scanning line of the display panel is scanned in sequence, and the data signal is supplied to the display cell according to the above scanning, to perform displays, the driving method comprising:

a step to detect a luminance decrease of the organic EL element;

a step to generate a reverse bias voltage pulse according to an amount of the above luminance decrease; and

a step to control applying the above reverse bias voltage pulse to the driving transistor in a time period in which the organic EL element emits no light.

### BRIEF DESCRIPTION OF DRAWINGS

FIG. 1 is a drawing illustrating one example of an equivalent circuit of a pixel of a conventional organic EL element (OEL).

FIG. 2 is a graph illustrating a change of a luminance (L) to a driving time of an organic EL element.

FIG. 3 is a drawing illustrating a display device using the active matrix display panel of the present invention.

FIG. 4 is a drawing illustrating a display cell PL_{j,i} related to a data line Xi and a scanning line Yj of a plurality of display cells PL_{1, 1}-PL_{n, m} of the display panel illustrated in FIG. 3.

FIG. 5 is a graph illustrating a change of a forward voltage (Vf) to a driving time of an organic EL element.

FIG. 6 is a graph illustrating a current shift (drain current: ld) to a driving time of an organic TFT.

FIG. 7 is a graph exemplifying a drain current (ld) to a gate voltage (Vgs) of an organic TFT in which a reverse bias voltage (Vr) is set as a parameter.

FIG. 8 is a drawing illustrating a circuit constitution of Embodiment 1 in a pattern diagram.

FIG. 9 is a timing chart in a pattern diagram illustrating a scanning pulse applied to each of scanning lines Y1-Yn and timing to apply a voltage to data lines X1-Xm of the display panel 11 in Embodiment 1.

FIG. 10 is a drawing illustrating a circuit constitution of Embodiment 2 in a pattern diagram.

FIG. 11 is a timing chart in a pattern diagram illustrating a scanning pulse applied to the scanning line and timing to apply a voltage to the data line Xj (j=1-m) in Embodiment 2.

FIG. 12 is a drawing illustrating the constitution of the color display device of Embodiment 4 in a pattern diagram.

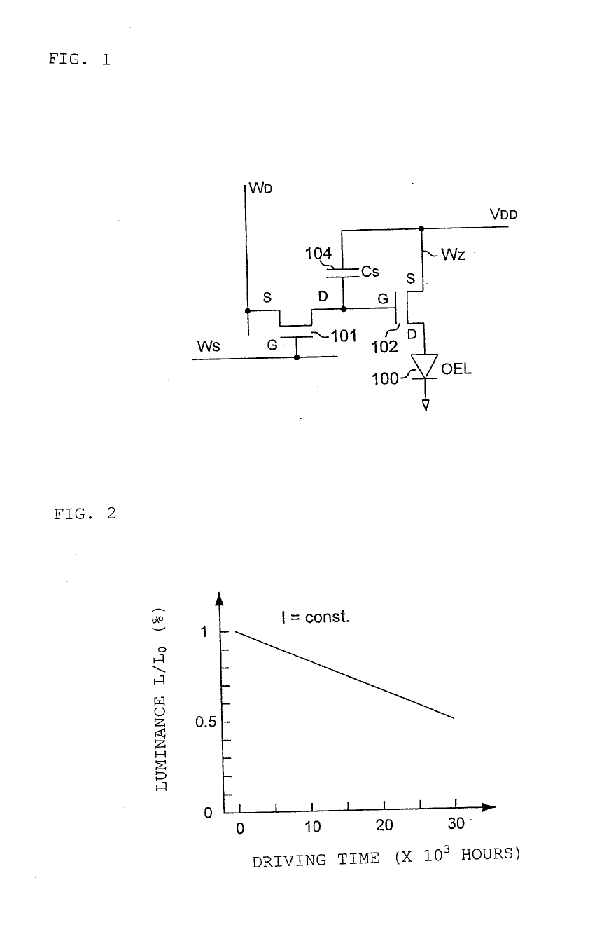

### DESCRIPTION OF EMBODIMENTS

Below, the embodiments of the present invention will be described in detail by referencing the drawings. In the drawings described below, parts substantively equivalent are given the same referential marks.

### EXAMPLE 1

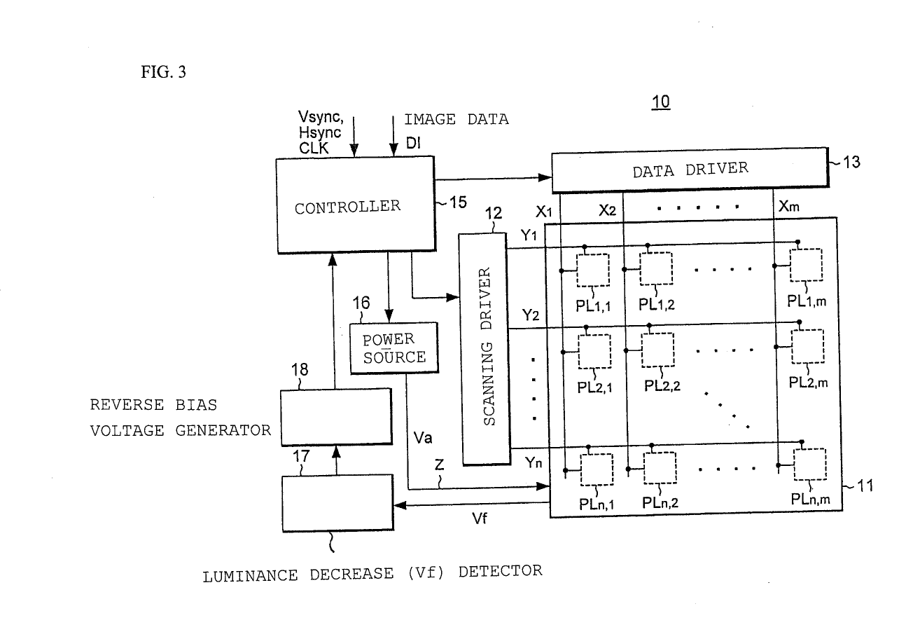

FIG. 3 illustrates a display device 10 using the active matrix display panel of the present invention. This display device 10 is equipped with a display panel 11, scanning driver 12, data driver 13, controller 15, power source driving a light emitting element 16, luminance decrease detector 17, and reverse bias voltage generator 18.

The display panel 11 is an active matrix type consisting of m×n (m and n are integers equal to or more than two) display cells, which has a plurality of data lines X1-Xm (Xi: i=1-m) each of which is disposed in parallel, a plurality of scanning lines Y1-Yn (Yj: j=1-n), and a plurality of display cells PL_{1,1}-PL_{n,m}. The display cells PL_{1, 1}-PL_{m,n} are disposed at an intersecting part of the data lines X1-Xm and the scanning lines Y1-Yn, all of which has the same constitution. A driving voltage of a light emitting element (Va) is supplied to the display cells PL_{1, 1}-PL_{n, m} from a power source 16 via a power source line Z. In the description of this embodiment, the display device 10 is a black-and-white display device and each display cell PL comprises one pixel as an example. However, the display device 10 may be a color display device and in order to display colors, three display cells of red (R), green (G), and blue (B) may comprise one pixel, for example.

FIG. 4 illustrates a display cell PL_{j,i} out of a plurality of display cells PL_{1, 1}-PL_{n,m} of the display panel 11 that is related to the data line Xi (i=1, 2, . . . , m) and the scanning line Yj (j=1, 2, . . . , n). More specifically, it is equipped with selective and driving TFTs (thin film transistor) 21, 22, a data storing capacitor (Cs) 24, and an organic EL (Electroluminescent) light emitting element (OEL) 25. In the description below, the driving TFT 22 is a p-channel TFT as an example, however, it is the same with an n-channel TFT.

A gate G of the selective TFT (TI) 21 is connected to the scanning line Yj, and a source S thereof is connected to the data line Xi. The gate G of the driving TFT (T2) 22 is connected to a drain D of the selective TFT 21. The source S of the TFT 22 is connected to the power source line Z so that a power source voltage (positive voltage Va) is supplied from the power source 16. A drain of the TFT 22 is connected to the anode of the EL element 25. The cathode of the EL element 25 is connected to a given potential (in this embodiment, grounded). One end (first terminal; electrode E1) of the capacitor (Cs) 24 is connected to the gate (and the drain of the selective TFT 21) of the driving TFT, while the other end (second terminal; electrode E2) is connected to the source S of the driving TFT. The scanning lines Y1-Yn of the display panel 11 are connected to the scanning driver 12, while the data lines X1-Xm are connected to the data driver 13.

An image signal DI, vertical synchronization signal Vsync, horizontal synchronization signal Hsync, and system clock CLK are supplied to the controller 15. The vertical synchronization signal Vsync, horizontal synchronization signal Hsync, and system clock CLK are used to generate a scanning control signal and a data control signal so as to drive and control gradation of the display panel 11 according to the image signal DI. The scanning control signal is supplied to the scanning driver 12, while the data control signal is supplied to the data driver 13. The controller 15 controls the entirety of the display device 10, that is to say, the scanning driver 12, data driver 13, power source driving a light emitting element 16, luminance decrease detector 17, and reverse bias voltage generator 18.

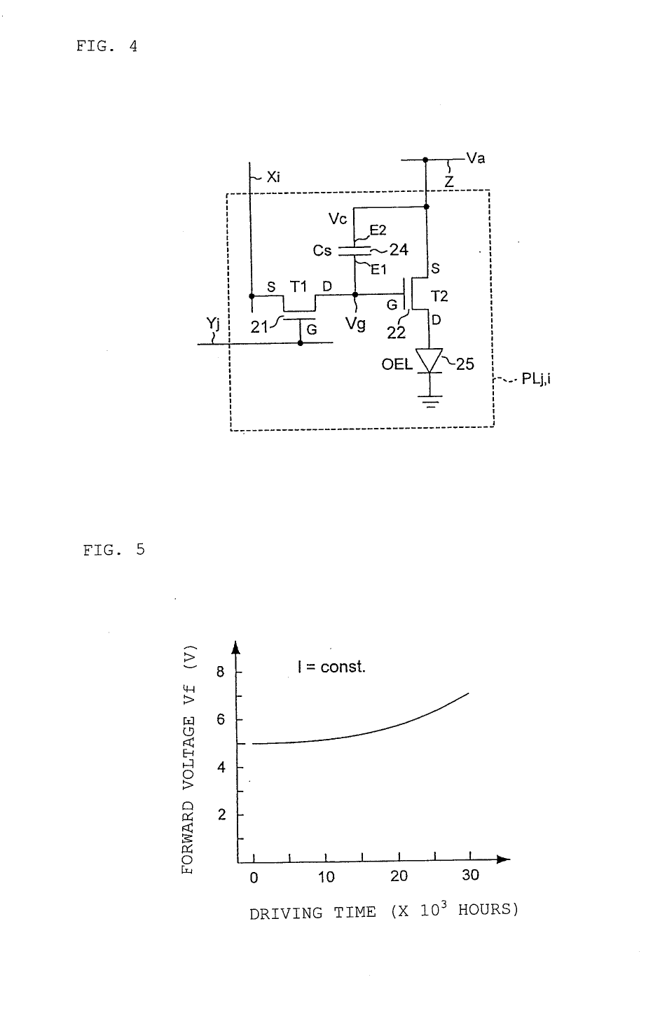

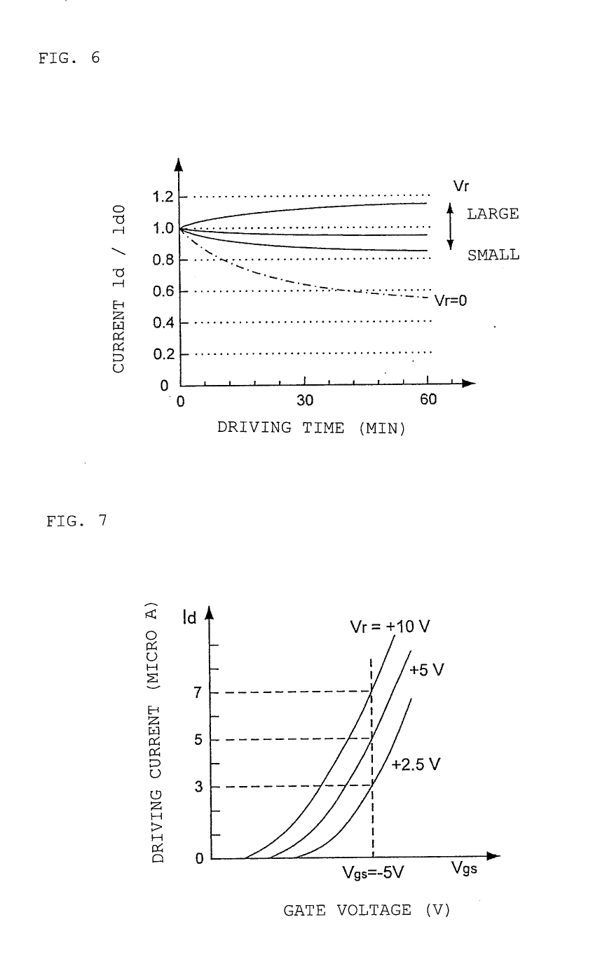

FIG. 5 is a graph illustrating a change of a forward voltage (Vf) to the driving time of the organic EL element (OEL). FIG. 5 illustrates the change in a pattern diagram when a driving current (I) is constant. As illustrated in FIG. 5, the forward voltage (Vf) of the organic EL element changes (increases) according to the driving time.

FIG. 6 is a graph illustrating a current shift (drain current: ld) to the driving time of the organic TFT. The vertical axis of the graph shows the drain current (ld) of the organic TFT by standardizing the drain current (ld₀) as 1 (100%) when the driving time is 0. The horizontal axis shows the driving time t (unit: minute). That is to say, as illustrated in FIG. 6, in an organic TFT used for a driving transistor or the like, if a forward bias is applied to a gate continuously, a drain current keeps decreasing (Vr=0, shown in a broken line), however, it is possible to compensate the decrease of the drain current by applying a reverse bias voltage. Depending on an amount of the reverse bias voltage to apply, a threshold voltage (Vth) of the organic TFT changes (to be described below), hence the change of the drain current to the driving time of the organic TFT fluctuates even if the voltage of the display signal is constant. That is to say, as the reverse bias voltage increases, the drain current decreases less, and the drain current increases more than at the initial time (driving time is O) depending on the amount of the reverse bias voltage.

FIG. 7 is a graph exemplifying a drain current (ld) to a gate voltage (Vgs) of an organic TFT in which a reverse bias voltage (Vr) is a parameter. Specifically, it illustrates an ld-Vgs curve after it is driven 60 minutes in which the gate voltage (Vgs) is −5V and the reverse bias voltage (Vr) is +2.5V, +5V, and +10V respectively. That is to say, as illustrated in the drawing, as the reverse bias voltage increases, the threshold voltage (Vth) of the organic TFT shifts in a direction to decrease, consequently the drain current (that is to say, the driving current of the organic EL element) increases. Conversely, if the reverse bias voltage decreases, the threshold voltage (Vth) shifts in a direction to increase, consequently the drain current decreases.

By using the above characteristic, it is possible to adjust the drain current of the organic TFT (the current driving the organic EL element) without changing the voltage of the display signal, thereby compensating the luminance change (decrease) to the driving time of the organic EL element. Below, the driving method using the characteristic of the organic TFT and the characteristic of the organic EL element as described above will be specifically described.

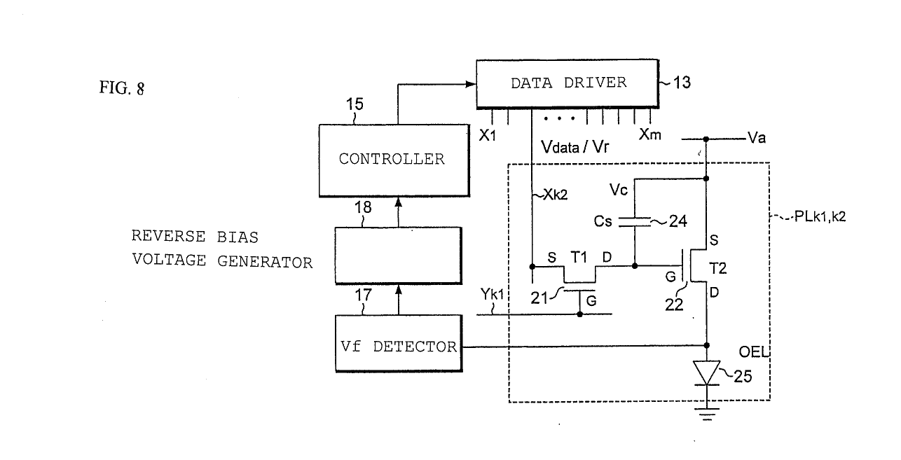

FIG. 8 is a drawing illustrating a circuit constitution of Embodiment 1 in a pattern diagram. In Embodiment 1, the above luminance decrease detector 17 is constituted as a forward voltage detector to detect a change of the forward voltage (Vf) of the organic EL element (OEL) 25. That is to say, the luminance decrease detector (referred to as a forward voltage detector in this embodiment) 17 detects the forward voltage (Vf) of the organic EL element (OEL) 25 of a given display cell PL_{k1,} ₖ₂ (display cell related to the scanning line Yk1 and the data line Xk2) of the display panel 11, thereby supplying the detected voltage to the reverse bias voltage generator 18. The reverse bias voltage generator 18 generates a reverse bias voltage having an amount according to the forward voltage of the OEL 25 detected, thereby supplying it to the controller 15. More specifically, in the description of this embodiment, a reverse bias voltage having an amount in proportion to an increase (difference from the initial value) of the forward voltage of the OEL 25 is generated so as to apply to the organic TFT (driving TFT) 22 as an example.

The controller 15 supplies to the data driver 13 the reverse bias voltage and a control signal so as to apply the reverse bias voltage to the driving TFT 22. The data driver 13 supplies the reverse bias voltage or the data voltage (Vdata) to each display cell via the data line Xi (i=1, 2, . . . , m) on the basis of the control of the controller 15.

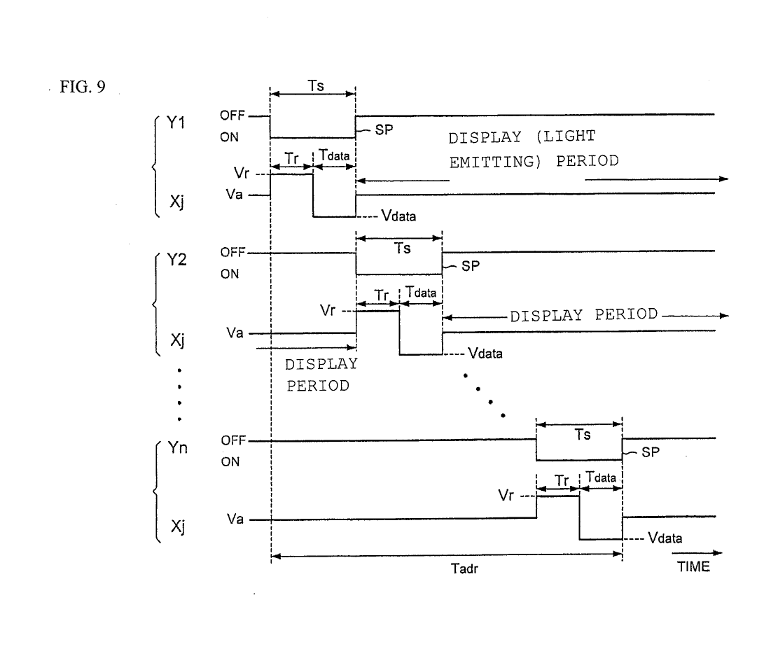

Next, the operation of the forward voltage detector 17 and the reverse bias voltage generator 18 and the application control of the reverse bias voltage of the controller 15 will be described in detail. FIG. 9 is a timing chart in a pattern diagram illustrating a scanning pulse applied to each of scanning lines Y1-Yn and timing to apply a voltage to data lines X1-Xm of the display panel 11.

In each image frame of an input image data signal, a scanning pulse SP is applied to the first to the nth scanning lines (Y1-Yn) in sequence so as to perform the line sequential scanning (addressing period: Tadr). First, when the scanning pulse SP is applied to the scanning line Y1 so as to select the scanning line Y1 (scanning line Y1 is on, selective period Ts), the selective TFT 21 becomes conductive so that the reverse bias voltage (Vr) is supplied from the data driver 13 to the data line Xi (i=1, 2, . . . , m). Hence, during the supplying period of the reverse bias voltage, the reverse bias voltage is applied to the gate of the driving TFT 22 of the display cell PL_{1,i} (i=1, 2, . . . , m) connected to the scanning line Y1 (the applying period is constant and Tr<Ts). After the applying period Tr of the reverse bias voltage elapses, an image data signal (data voltage Vdata) is supplied to the electrode E1 of the capacitor 24 from the data driver 13 through the data line Xi (i=1, 2, . . . , m). A load corresponding to the data voltage Vdata is accumulated in the'capacitor 24 so as to hold the voltage. Then a drain current flows in the driving TFT 22 according to the gate voltage Vgs (=Vdata−Va). Therefore, the organic light emitting element (OEL) 25 is driven with luminance according to the image data signal so as to emit light.

After the data of the scanning line Y1 is written (after an elapse of the selective period Ts), a scanning pulse SP is applied to a scanning line Y2 so as to select the scanning line Y2 (selective period Ts). Similarly to the above case of the scanning line Y1, during the applying period Tr of the reverse bias voltage, a reverse bias voltage pulse is applied to the gate of the driving TFT 22 of the display cell PL_{2,i} (i=1, 2, . . . , m) which is connected to the scanning line Y2. After an elapse of the reverse bias applying period Tr, the image data signal (data voltage Vdata) is supplied to the data line Xi (i=1, 2, . . . , m) from the data driver 13 so that the OEL 25 of the display cell PL_{2,i} (i=1, 2, . . . , m) is driven with luminance according to the image data signal so as to emit light.

Similarly, the sequential line scanning is performed up to the scanning line Yn (addressing period: Tadr), and the reverse bias voltage is applied in all the display cells of the display panel 11, and the display control is performed according to the image data signal. In the following image frame also, the reverse bias voltage is applied and the display control is performed similarly. However, it is acceptable to apply the reverse bias voltage in every several frames instead of applying it in all the frames.

Hence, by increasing the reverse bias voltage (that is to say, a voltage value of a rectangle pulse) to apply to the driving TFT 22 in proportion to the increase of the forward voltage of the organic EL element (OEL), it is possible to increase the driving current of the OEL without changing the voltage of a display signal. Accordingly, it is possible to compensate and reduce the chronological luminance decrease of the OEL.

In the above description, the reverse bias voltage was applied during the addressing period (writing period). However, the applying period of the reverse bias voltage is not limited to the writing period. That is to say, since the organic EL element does not emit light because of the reverse bias voltage applied, it is possible to apply the reverse bias voltage over a time period in which the organic EL element does not emit light. For example, a blanking period, a time period between frames or the like may be used.

In the above description, the forward voltage detector 17 detected the forward voltage of the organic EL element (OEL) 25 of a given display cell PL_{k1, k2} of the display panel 11 as an example, however, the forward voltage detector 17 may be constituted to detect the forward voltage of a plurality of OELs 25 of the display panel 11. Furthermore, in this case, by using a given statistical method such as an average value of the forward voltage of the OELs 25 or the like, it is possible to comprise it so as to compensate the luminance decrease of the whole display panel 11.

### EXAMPLE 2

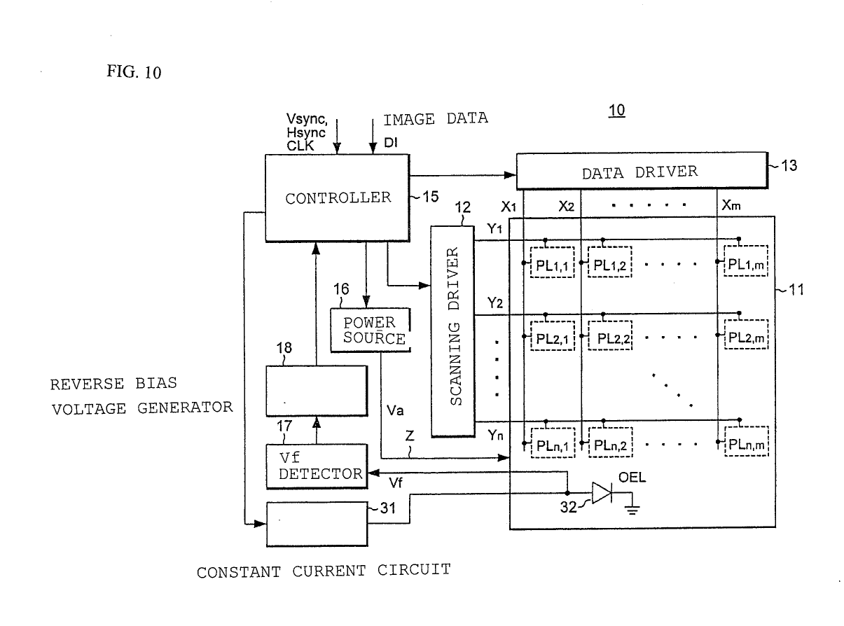

In the description of the above Embodiment 1, the forward voltage of the organic EL element (OEL) 25 of a given display cell PL_{k1,k2} of the display panel 11 was detected as an example. However, in this embodiment, the monitoring OEL 32 is provided separately from the OEL 25 of the display panel 11 so as to detect the forward voltage of the monitoring OEL 32. FIG. 10 is a drawing illustrating a circuit constitution of Embodiment 2 in a pattern diagram.

More specifically, as illustrated in FIG. 10, the monitoring OEL 32 is driven by a given driving current from a constant current circuit 31. The forward voltage detector 17 that is a luminance decrease detector detects the forward voltage (Vf) of the OEL 32, thereby supplying the detected voltage to the reverse bias voltage generator 18. The reverse bias voltage generator 18 generates a reverse bias voltage according to the forward voltage of the OEL 32 detected, thereby supplying it to the controller 15. The controller 15 supplies to the data driver 13 the reverse bias voltage and a control signal so as to apply the reverse bias voltage to the OEL 25 of the display panel 11. The data driver 13 supplies the reverse bias voltage or the data voltage (Vdata) to the driving TFT 22 of each display cell via the data line Xi (i=1, 2, . . . , m) on the basis of the control of the controller 15. It is possible to apply the reverse bias voltage and to apply the data voltage signal to the OEL 25 of the display panel 11 similarly to Embodiment 1 described above.

This embodiment has a constitution in which the monitoring OEL 32 is provided so that it serves as a detection criterion of the forward voltage so as to detect the forward voltage when driven by a constant driving current. That is to say, the monitoring OEL 32 is driven by a constant current from the constant current circuit 31 so as to detect the forward voltage. Accordingly, it is possible to have a more precise forward voltage as a criterion, wherein it is possible to precisely compensate the luminance decrease, more reflecting the luminance decrease of display cells of the whole display panel 11. The driving current of the OEL 32 may be a set constant current, or a current according to a display signal.

### EXAMPLE 3

In the above description of Embodiment 1 and 2, the applying period (Tr) of the reverse bias was constant, wherein an amount of the reverse bias voltage was applied according to the forward voltage (Vf) of the organic EL element (OEL). However, the amount of the reverse bias voltage may be constant and the applying period of the reverse bias voltage (or the width of the reverse bias voltage pulse) may be adjusted according to the forward voltage (Vf) of the organic EL element.

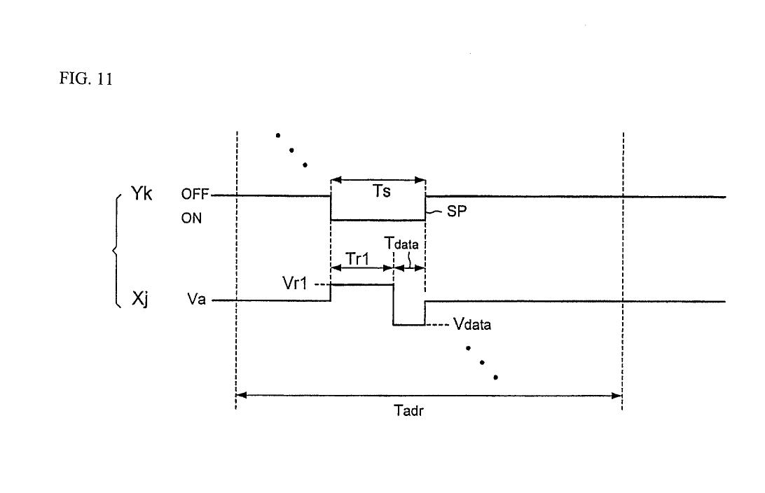

Similarly to FIG. 9, FIG. 11 is a timing chart in a pattern diagram illustrating a scanning pulse to apply to a scanning line and voltage timing to apply to a data line Xj (j=1-m), however, for the sake of an easy description and understanding, it illustrates only the kth scanning line Yk (k=1-n).

In this embodiment, the reverse bias voltage generator 18 is constituted so that the reverse bias voltage (Vr1) is applied to the driving TFT 22 during the applying period (Tr1, the width of the reverse bias voltage pulse) according to the forward voltage of the organic EL element (OEL) detected. Specifically, for example, in order to obtain an effect of applying the reverse bias similar to Embodiment 1, in this embodiment, the reverse bias voltage (Vr1) is constant, and the amount of the reverse bias voltage (Vr1) is adjusted to become smaller than that of Embodiment 1 (Vr), whereas the applying period of the reverse bias (Tr1) is adjusted to become longer than that of Embodiment 1 (Tr). Conversely, the amount of the reverse bias voltage (Vr1) of this embodiment is adjusted to become larger than that of Embodiment 1 (Vr), while the applying period of the reverse bias (Tr1) is adjusted to become shorter than that of Embodiment 1 (Tr).

### EXAMPLE 4

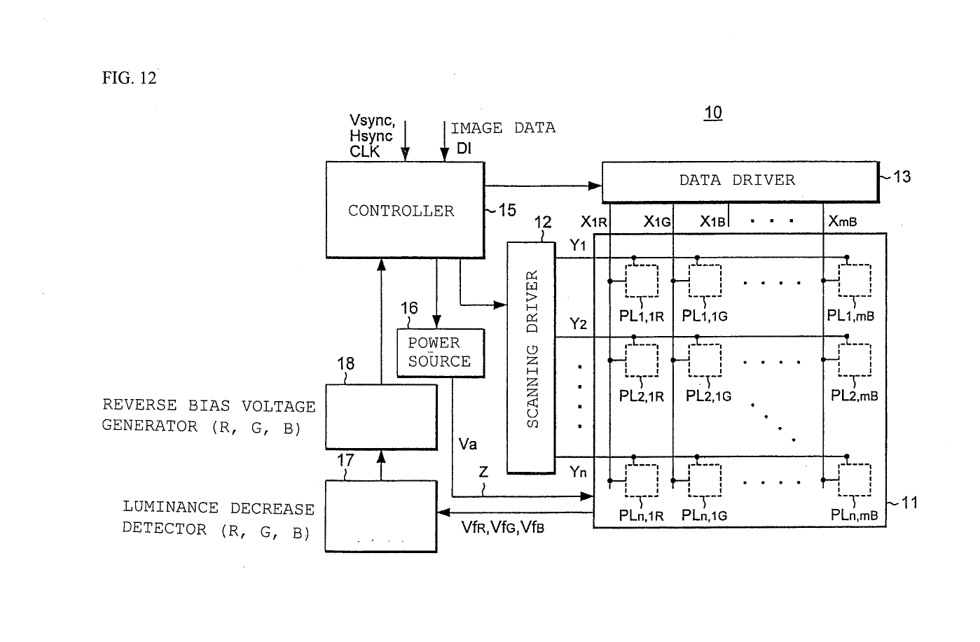

The present invention can be applied to color display devices. FIG. 12 illustrates the constitution of the color display device 10 of this embodiment in a pattern diagram. That is to say, pixels consisting of three display cells of red (R), green (G), blue (B) are disposed on a scanning line Yk in sequence. Specifically, pixels (PL_{k,1R}, PL_{k,1G}, PL_{k,1B}), (PL_{k,2R}, PL_{k,2G}, PL_{k,2B}), . . . , (PL_{k,mB}, PL_{k,mB}, PL_{k,mB}) are disposed in sequence.

In this embodiment, the forward voltage detector 17 detects the forward voltages (VfR, VfG, VBf) of the organic

EL element (OEL) 25 of display cells (PL_{k1, k2R}, PL_{k1, k2G}, PL_{k1, k2G}) of given pixels of the display panel 11, thereby supplying the detected voltage to the reverse bias voltage generator 18. The reverse bias voltage generator 18 generates reverse bias voltages (VrR, VrG, Vrf) having an amount according to the forward voltages (VfR, VfG, VBf) of the OEL 25 detected, thereby supplying them to the controller 15. The data driver 13 supplies the reverse bias voltages (VrR, VrG, Vrf) to each display cell via the data lines (X1R, X1G, X1B)-(XmR, XmG, XmB) corresponding to R, G, B on the basis of the control of the controller 15 according to the scanning of each of scanning lines Y1-Yn.

That is to say, in this embodiment, the color display device is constituted in which the reverse bias voltage having an amount in proportion to an increase of the forward voltage of the OEL 25 of each color R, G, B is generated so as to apply to the organic TFT (driving TFT) 22 corresponding to the OEL 25 of each color R, G, B.

According to this embodiment, it is possible to increase the driving current of the OEL 25 of each color R, G, B without changing the voltage of a display signal. Accordingly, even if the luminance deterioration of each color of the OEL is different, it is possible to compensate and reduce the luminance decrease by each color. That is to say, since the luminance decrease can be compensated by each color, it is possible to provide a color display device without luminance deterioration yet with an excellent color rendering property.

In the description of the above Embodiment, in order to detect the luminance decrease of the organic EL element (OEL), the forward voltage of the organic EL element was detected as an example, however, it is not limited to this. For example, modification examples may be cited as below.

(A1) As described above, since the luminance of the organic EL element decreases with the driving time, it is acceptable to constitute it in which the amount of the reverse bias voltage, the applying period or the like is changed on the basis of the cumulative driving time of the display panel 11, that is to say, the organic EL element. In this case, the luminance decrease detector 17 may be constituted to be a circuit to calculate the cumulative driving time of the organic EL element of the display panel 11.

(A2) As a direct method used against the luminance decrease of the organic EL element, it is acceptable to constitute it in which a light receiving element is provided so as to detect the emission luminance of the organic EL element so as to change the amount of the reverse bias voltage, the applying period or the like on the basis of the luminance decrease detected.

(A3) In the description of the above embodiment, the amount of the reverse bias voltage to be applied, the applying period or the like is determined in proportion to an increase of the forward voltage of the organic EL element, however, it is not limited to this. For example, the amount of the reverse bias voltage to the amount of the forward voltage of the organic EL element may be non-linear (super-linear or sub-linear). The point is that a decrease portion of the luminance of the organic EL element (change of a forward voltage) is compensated by an increase of the drain current of the driving TFT caused by applying the reverse bias voltage.

Furthermore, needless to say, the above embodiments and modification examples may be combined or modified to be used for the application. For example, it is possible to apply Embodiment 2 to a color display device (Embodiment 4), and constitute the monitoring OEL of each color R, G, B to be provided individually. In this case, since a dedicated monitoring OEL is used, it is possible to precisely detect the luminance decrease (change of a forward voltage) and to realize a color display device having an excellent color rendering property.

Furthermore, according to the luminance decrease of the organic EL element, both the amount and the applying period of the reverse bias voltage (or the voltage value and the width of the reverse bias voltage pulse) may be adjusted. In this case, it is possible to compensate the luminance decrease precisely in a dynamic range.

As described above in detail, according to the present invention, the chronological luminance decrease of the organic EL element is detected so that the reverse bias voltage is adjusted to apply to the driving TFT, which drives the organic EL element according to the amount of the luminance decrease. That is to say, the reverse bias voltage is adjusted and the driving current to drive the organic EL element is increased according to the luminance decrease, thereby compensating and reducing the chronological luminance decrease of the organic EL element.

Therefore, it is possible to precisely compensate the chronological luminance decrease of the organic EL element in the organic EL display and to provide a reliable organic EL display. Furthermore, it is possible to provide a reliable color display device having an excellent color rendering property.

### REFERENCE SIGNS LIST

10 . . . DISPLAY DEVICE
11 . . . DISPLAY PANEL
12 . . . SCANNING DRIVER
13 . . . DATA DRIVER
15 . . . CONTROLLER
16 . . . POWER SOURCE DRIVING A LIGHT EMITTING ELEMENT
17 . . . LUMINANCE DECREASE DETECTOR
18 . . . REVERSE BIAS VOLTAGE GENERATOR
21 . . . SELECTIVE TFT
22 . . . DRIVING TFT
24 . . . HOLDING CAPACITOR
25 . . . ORGANIC EL ELEMENT

1. A display device having an active matrix type display panel consisting of a plurality of display cells, each of which has an organic EL (Electroluminescent) element and a driving transistor which drives the organic EL element on the basis of a data signal wherein each scanning line of the display panel is scanned in sequence, and the data signal is supplied to the display cell according to the scanning, to perform displays, the display device comprising:
a luminance decrease detector to detect a luminance decrease of the organic EL element;
a reverse bias voltage generator to generate a reverse bias voltage pulse according to an amount of the luminance decrease; and
a controller to control applying the reverse bias voltage pulse to the driving transistor in a time period in which the organic EL element emits no light.

2. The display device according to claim 1, wherein the luminance decrease detector detects a luminance decrease of the organic EL element on the basis of an amount of a forward voltage of the organic EL element.

3. The display device according to claim 1, further comprising a monitoring organic EL element different from the organic EL element of the plurality of display cells, wherein the luminance decrease detector detects a luminance decrease of the organic EL element on the basis of an amount of a forward voltage of the monitoring organic EL element.

4. The display device according to claim 1, wherein the reverse bias voltage pulse has a voltage value according to an amount of the luminance decrease.

5. The display device according to 3 claim 1, wherein the reverse bias voltage pulse has a pulse width according to an amount of the luminance decrease.

6. The display device according to claim 1, wherein the driving transistor is an organic TFT (Thin Film Transistor).

7. The display device according to claim 1, wherein the display cell includes an organic EL element of three colors; the luminance decrease detector detects a luminance decrease of each organic EL element of the three colors; the reverse bias voltage generator generates a reverse bias voltage pulse according to an amount of the luminance decrease of each organic EL element of the three colors; and the controller controls to apply the reverse bias voltage pulse to each organic EL element of the three colors in accordance with each organic EL element of the three colors in the display cell.

8. A driving method of a display device comprising an active matrix type display panel consisting of a plurality of display cells each having an organic EL (Electroluminescent) element and a driving transistor which drives the organic EL element on the basis of a data signal wherein each scanning line of the display panel is scanned in sequence, and the data signal is supplied to the display cell according to the scanning, to perform displays, the driving method comprising:
a step to detect a luminance decrease of the organic EL element;
a step to generate a reverse bias voltage pulse according to an amount of the luminance decrease; and
a step to control applying the reverse bias voltage pulse to the driving transistor in a time period in which the organic EL element emits no light.

9. The driving method according to claim 8, wherein the step to detect the luminance decrease detects the luminance decrease on the basis of an amount of a forward voltage of the organic EL element.

10. The driving method according to claim 8, wherein the display panel includes a monitoring organic EL element different from the organic EL element of the plurality of display cells,
so that the step to detect the luminance decrease detects a luminance decrease of the organic EL element on the basis of an amount of a forward voltage of the monitoring organic EL element.

11. The driving method according to claim 8, wherein the reverse bias voltage pulse has a voltage value according to an amount of the luminance decrease.

12. The driving method according to claim 8, wherein the reverse bias voltage pulse has a pulse width according to an amount of the luminance decrease.

13. The driving method according to claim 8, wherein the driving transistor is an organic TFT (Thin Film Transistor).
